(19) United States
(12) Patent Application Publication
(10) Pub. No.: US 2013/0074951 A1
(43) Pub. Date: Mar. 28, 2013

(54) Fuel Cup

(71) Applicant: Continental Automotive GmbH, Hannover (DE)

(72) Inventors: Daniel Marc, Livorno (IT); Andrea Puccini, San Miniato (IT)

(73) Assignee: Continental Automotive GmbH, Hannover (DE)

(21) Appl. No.: 13/678,079

(22) Filed: Nov. 15, 2012

Related U.S. Application Data
(63) Continuation-in-part of application No. PCT/EP2011/056351, filed on Apr. 20, 2011.

(30) Foreign Application Priority Data
May 18, 2010 (EP) 10005188.7

(51) Int. Cl. F02M 61/16

(52) U.S. Cl. CPC F02M 61/16
USPC 137/343

(57) ABSTRACT

A fuel cup including a central longitudinal axis and being fixable to an injector via a holder comprises a fuel cup body and a fixing element. This fuel cup is wherein said fixing element is a stamped tab affixed to said fuel cup body, and in that said stamped tab is designed to be engaged to said holder.

### CROSS-REFERENCE TO RELATED APPLICATIONS

This application is a Continuation-In-Part of International Application No. PCT/EP2011/056351 filed Apr. 20, 2011, which claims priority to EP Patent Application No. 10005188.7 filed May 18, 2010. The contents of which is incorporated herein by reference in its entirety.

### TECHNICAL FIELD

This disclosure relates to a fuel cup being fixable to an injector via a holder, whereby the fuel cup comprises a fixing element.

### BACKGROUND

EP 1 892 408 A1 discloses a fuel cup comprising above mentioned features. With this prior art fuel cup said fixing element is an integral part of the fuel cup in the form of a T-shaped protrusion of the outer surface of the fuel cup. Such a fuel cup can only be produced either by machining or by casting. However, such methods are expensive and technically complicated because of long machining time needed and because of the tiny dimension of the protrusion. On the other hand, deciding for casting as a method for producing such a fuel cup implies a large amount of tooling investment, which may be justified only for big volume production, but not for producing smaller lots of fuel cups of one and the same type. And in fact each type of fuel cups (and the respective holders and injectors) is designed and adapted to be used with a specific, given type of internal combustion engine. Accordingly, in practice the lots of identical fuel cups to be produced are not too big, and producing fuel cups of a given type having a fixing element as an integral part thereof by casting is also too expensive.

### SUMMARY

In one embodiment, a fuel cup including a central longitudinal axis, said fuel cup being fixable to an injector via a holder, and said fuel cup comprising a fuel cup body and a fixing element, wherein said fixing element is a stamped tab affixed to said fuel cup body, and in that said stamped tab is designed to be engaged to said holder.

In a further embodiment, said stamped tab is brazed or welded to said fuel cup body. In a further embodiment, said fuel cup body comprises a recess arranged at an outer surface of said fuel cup body, said stamped tab being engaged to said recess. In a further embodiment, an upper end of said stamped tab is bent outward of said fuel cup in a direction being orthogonal to said central longitudinal axis. In a further embodiment, an upper end of said stamped tab is designed T-shaped. In a further embodiment, an upper end of said stamped tab comprises at least one aperture.

In another embodiment, a fuel cup including a central longitudinal axis is fixable to an injector via a holder, and comprises a fuel cup body and a fixing element, and the fixing element is a stamped tab affixed to said fuel cup body, and provided to be engaged to said holder, and the fuel cup body comprises a recess arranged at an outer surface of the fuel cup body, the stamped tab being engaged to the recess.

### BRIEF DESCRIPTION OF THE DRAWINGS

Example embodiments will be explained in more detail below with reference to figures, in which:

FIG. 1: an injector assembly including a fuel cup according to one embodiment, a holder, and an injector,

FIG. 2: a fuel cup body (partially) and a stamped tab both parts not yet affixed to each other,

FIG. 3: the arrangement of FIG. 2, but affixed to each other,

FIGS. 4 and 5: two embodiments of a stamped tab,

FIG. 6: an arrangement of a fuel cup, a holder, and an injector, before being assembled

FIG. 7: the arrangement of FIG. 6, after having been assembled.

### DETAILED DESCRIPTION

Some embodiments provide a fuel cup comprising a fixing element, such an arrangement being fixable to an injector, whereby this arrangement can be manufactured faster, cheaper, and by applying less complicated production steps during manufacture.

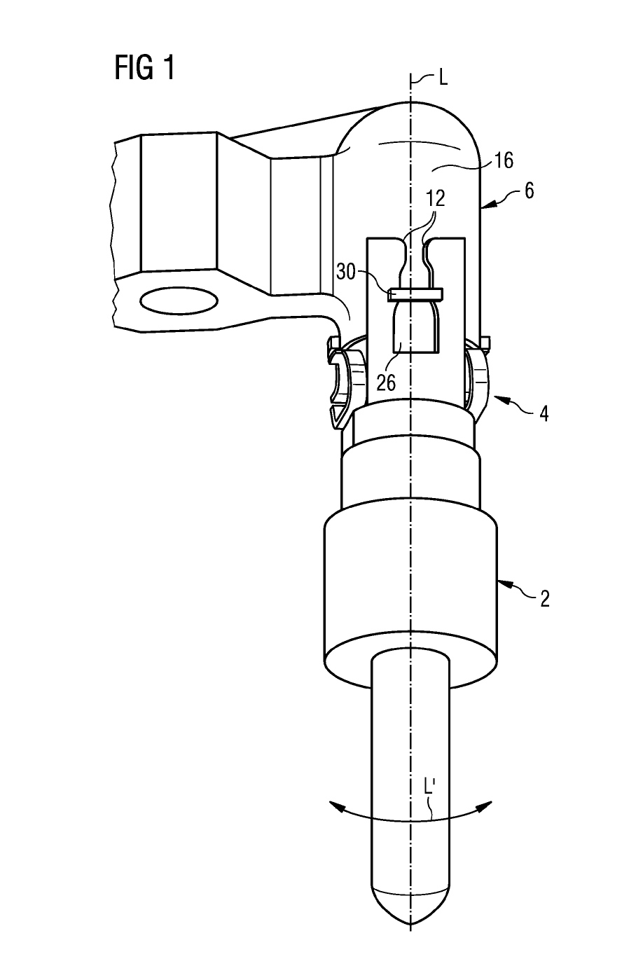

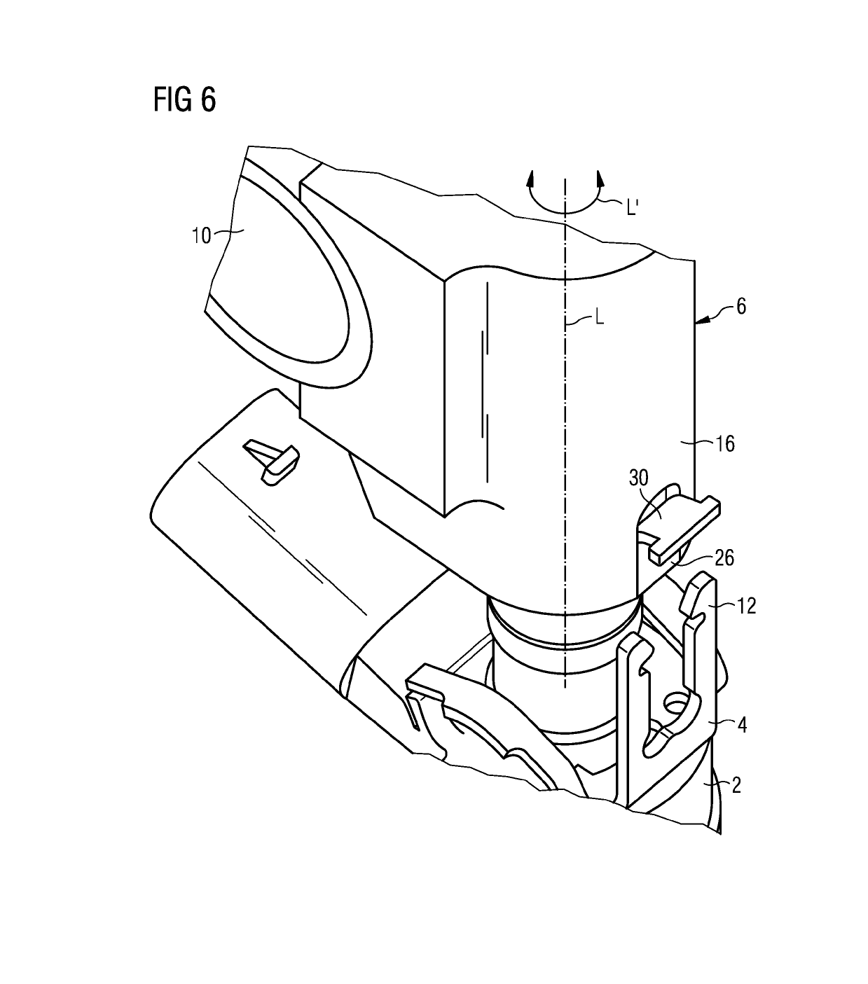

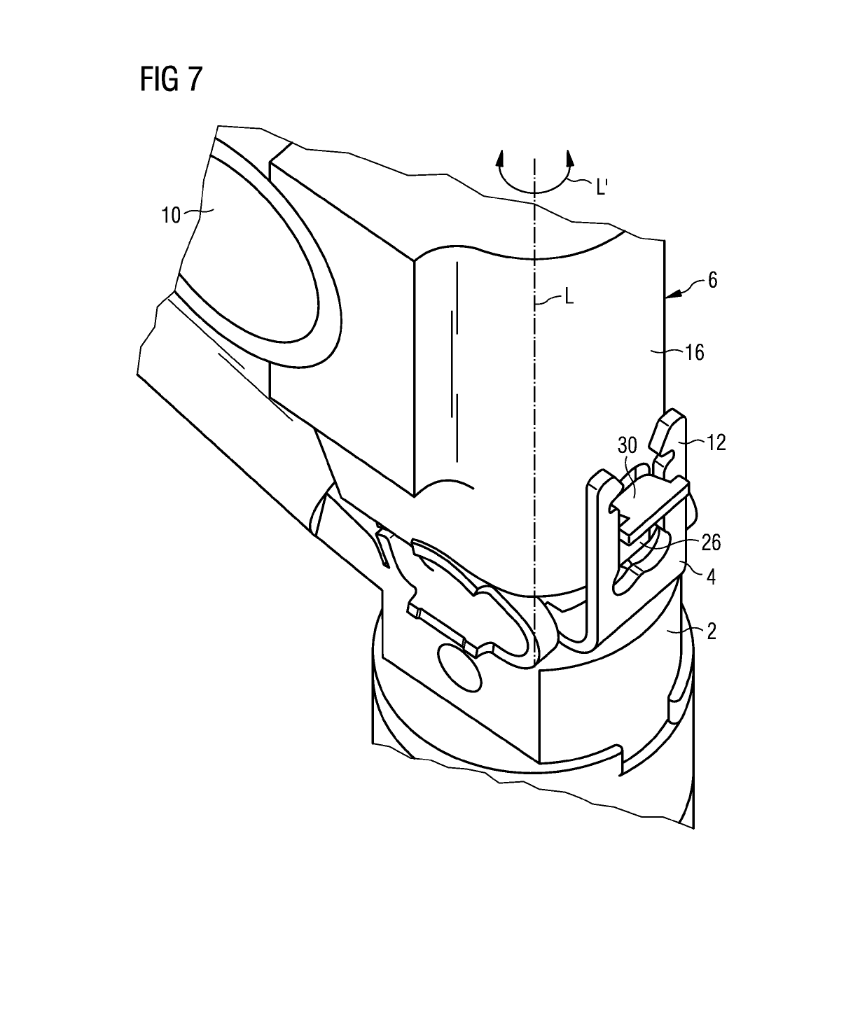

FIG. 1 shows a fuel cup 6 fixed to an injector 2 and a holder 4. The holder 4 and the injector 2 may be of the same construction as disclosed in prior art EP 1 892 408 A1. The fuel cup 6 is leak proof fixed to the injector 2 so that fuel may flow, under pressure, from a fuel rail 10 (not shown in FIG. 1, but in FIGS. 6 and 7) through the fuel cup 6 into the injector 2 for being injected into the cylinder head of an internal combustion engine (not shown). The fuel cup 6 comprises a fuel cup body 16 and a fixing element. Whereas the prior art fixing element is an integral part of the fuel cup, the fixing element of the fuel cup disclosed herein is a separate part in the form of a stamped tab 26, which is affixed to the fuel cup body 16. Accordingly, the disclosed fuel cup comprises (at least) two parts, namely the fuel cup body 16 and the stamped tab 26, which can be manufactured separately and independent from each other, and then be affixed to each other.

Compared with certain known fuel cups the fuel cup disclosed herein can be produced faster, by means of production processes and steps being less complicated, and with machines and tools being considerably cheaper in acquisition and maintenance. The fuel cup body 16 can be a forged or cast part. The fuel cup body 16 may be a stamped part, in particular a deep drawn part. In one development, producing the fuel cup body 16 comprises a step of machining for optimization.

For gaining these advantages, the fact that the fuel cup body and the stamped tab can be manufactured separately and independently from each other may be essential.

Fixing of the injector 2 in the fuel cup 6 along a central longitudinal axis L of the fuel cup 6 as well as in a rotational direction L′ around said central longitudinal axis L is accomplished by means of said holder 4, in connection and interaction with the stamped tab 26. Said fixing is essential, as any person skilled in the art knows, not only for having the fuel path from the fuel rail 10 to the cylinder head free of any leakage, even with higher pressures as used like in modern engines provided with gasoline direct injection or with diesel engines, but also for complying with the (more and more) restrictive rules defining limit values, which the exhaust gas must not exceed. Said fixing also has the advantage that a combination of fuel rail, fuel cup(s), holder(s) and injector(s) can be preassembled prior to mounting to an internal combustion engine or can be removed from such an engine (for instance for purposes of maintenance or repair) without loosing the orientation of the injectors with respect to their correct position in the cylinder head.

Said fixing is mainly accomplished by interaction between the stamped tab 26 of the fuel cup 6 and, for example, with forklike extensions 12 of the holder 4. This can be seen in more details in the other figures of the drawing.

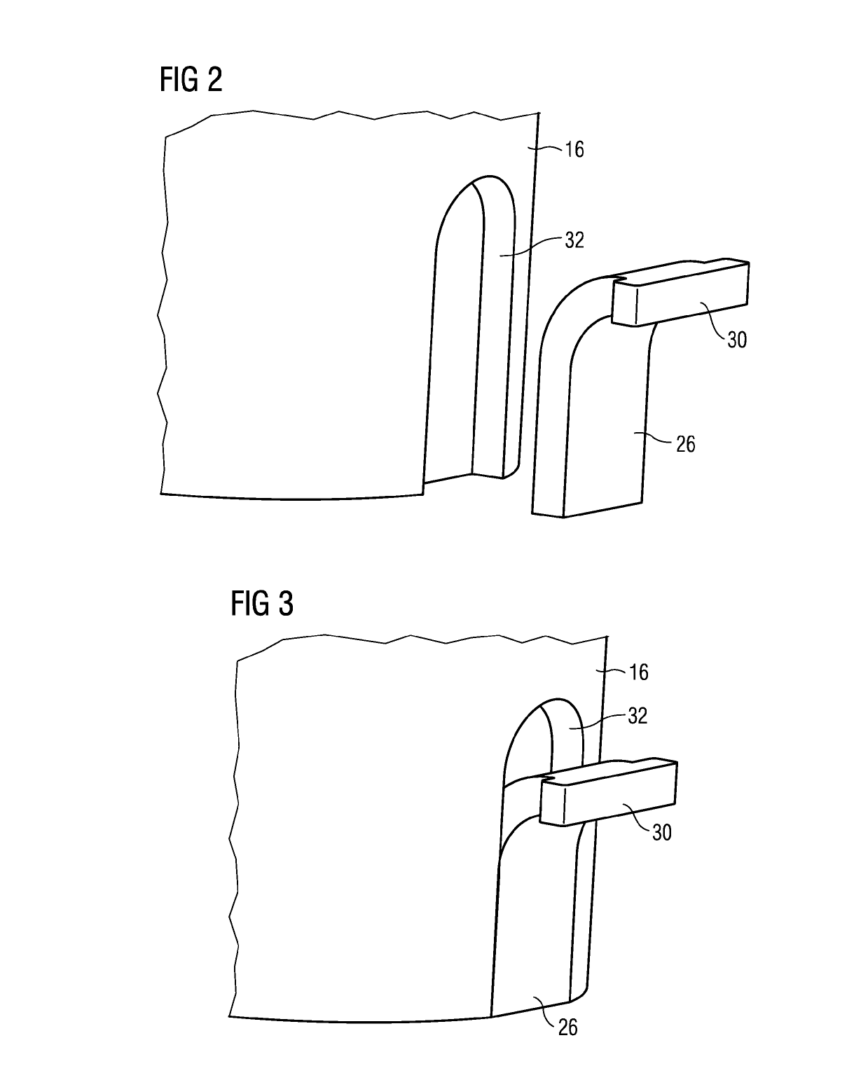

The stamped tab 26 may be affixed to the fuel cup body 16 by brazing or welding, whereby the fuel cup body 16 may comprise a recess 32 (see FIGS. 2, 3, 6, and 7) for receiving the stamped cup 26. Affixing may also be accomplished without the provision of said recess 32, i. e., directly onto the outer surface of the fuel cup body 16.

FIG. 2 shows, in greater details, part of the fuel cup body 16 and the stamped tab 26, not yet fixed to each other. An outer surface of the fuel cup body 16 is provided with a groove or a recess 32, designed to receive and engage the stamped tab 26 either by brazing or by welding or by interference, or by any other method being applicable.

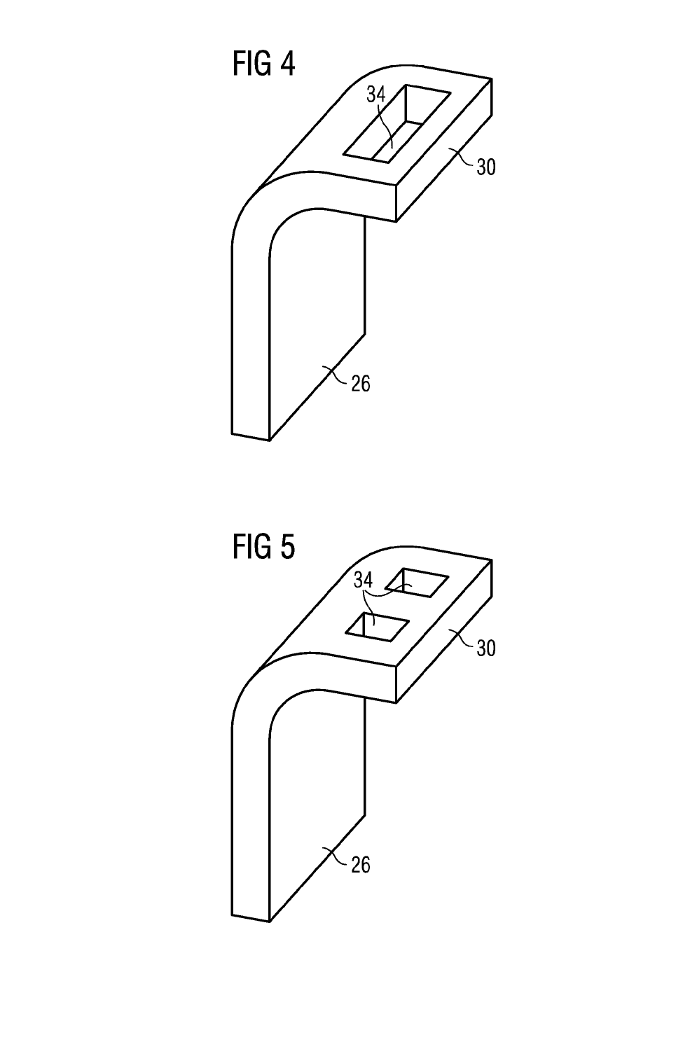

FIG. 3 shows the stamped tab 26 fixed to the fuel cup body 16 in the area of the recess 32.

The figures also show another embodiment of the stamped tab 26: an upper end 30 of the stamped tab 26 is bent outward in a direction orthogonal to the central longitudinal axis L. with the embodiments shown in FIGS. 2, 3, 6, and 7 the upper end 30 of the stamped tab 26 is designed T-shaped, whereas with the embodiments according to the FIGS. 4 and 5 the upper end 30 comprises one (FIG. 4) or two apertures 34 (FIG. 5).

The advantage of the T-shaped design of the upper end 30 of the stamped tab 26 can be seen from FIGS. 6 and 7:

FIG. 6 shows an injector 2, a holder 4, and a fuel cup 6 including the fuel cup body 16 and the stamped tab 26, fastened to the fuel cup body 16 in the area of the recess 32. whereas the holder 4 is already mounted to the injector 2 (see said prior art EP 1 892 408 A1), the fuel cup 6 is not yet mounted to the injector 2 and the holder 4. With this embodiment the holder 4 comprises two fork-like extensions 12, as already described. When pressing down the fuel cup 6 along its central longitudinal axis L in direction to the injector 2, the stamped tab 26 glides into the area between the two fork-like extensions 12 of the holder 4, whereby said extensions 12 slide into the area between the outer surface of the fuel cup body 16 and the T-shaped area of the upper end 30 of the stamped tab 26. Due to the geometrical design of the extensions 12 the fork-like extensions 12 are first forced apart and then they spring back again. As a result, the stamped tab 26 is clamped between said two fork-like extensions 12 of the holder 4 in a way so that the fuel cup 6 can neither move in a direction along the central longitudinal axis L off from the holder 4 and from the injector 2 nor can it be distorted in a rotational direction L′ around the central longitudinal axis L. As a result, the fuel cup 26, the holder 4 and injector 2 are fixed to each other. This situation is demonstrated in FIG. 7.

In other embodiments, where the upper end 30 of the stamped tab 26 is designed to have one or two apertures 34 (see FIGS. 4 and 5), one fork-like extension 12 of the holder 4 (or both in case of two apertures 34) slide(s) through the aperture 34 (or, respectively, through the apertures 34), when fuel cup 26, holder 4 and injector 2 are assembled. Accordingly, also with these embodiments said fixing may be accomplished very precisely.

The invention is not limited to specific embodiments by the description on the basis of said exemplary embodiments but comprises any combination of elements of different embodiments. Moreover, the invention comprises any combination of claims and any combination of features disclosed by the claims.

What is claimed is:

1. A fuel cup, comprising:
a central longitudinal axis,
a fuel cup body and a fixing element,
wherein said fuel cup is fixable to an injector via a holder,
wherein said fixing element is a stamped tab affixed to said fuel cup body, and
wherein said stamped tab is configured for engagement with said holder.

2. The fuel cup according to claim 1, wherein said stamped tab is brazed or welded to said fuel cup body.

3. The fuel cup according to claim 1, wherein said fuel cup body comprises a recess arranged at an outer surface of said fuel cup body, said stamped tab being engaged to said recess.

4. The fuel cup according to claim 1, wherein an upper end of said stamped tab is bent outward of said fuel cup in a direction being orthogonal to said central longitudinal axis.

5. The fuel cup according to claim 1, wherein an upper end of said stamped tab is designed T-shaped.

6. The fuel cup according to claim 1, wherein an upper end of said stamped tab comprises at least one aperture.

7. A fuel cup having a central longitudinal axis, wherein the fuel cup is fixable to an injector via a holder,
wherein the fuel cup comprises a fuel cup body and a fixing element,
wherein the fixing element is a stamped tab affixed to said fuel cup body, and configured to be engaged to said holder, and
wherein the fuel cup body comprises a recess arranged at an outer surface of the fuel cup body, the stamped tab being engaged with the recess.

8. The fuel cup according to claim 7, wherein said stamped tab is brazed or welded to said fuel cup body.

9. The fuel cup according to claim 7, wherein an upper end of said stamped tab is bent outward of said fuel cup in a direction being orthogonal to said central longitudinal axis.

10. The fuel cup according to claim 7, wherein an upper end of said stamped tab is designed T-shaped.

11. The fuel cup according to claim 7, wherein an upper end of said stamped tab comprises at least one aperture.
